(19) United States
(12) Patent Application Publication
(10) Pub. No.: US 2011/0041640 A1
(43) Pub. Date: Feb. 24, 2011

(54) SELECTOR LEVER FOR SPEED CHANGE TRANSMISSION

(75) Inventor: Jens RATTKE, Hohenstein (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/841,963

(22) Filed: Jul. 22, 2010

(30) Foreign Application Priority Data
Jul. 24, 2009 (DE) 102009034695.3

(51) Int. Cl. G05G 5/08

(52) U.S. Cl. 74/473.26

(57) ABSTRACT

A selector lever is provided for speed change transmissions, which is movable into various lever positions to select various operating and driving steps or gears. The selector lever includes, but is not limited to a handle at one end, an unlocking bar, which is movable in the extension direction, is received in the selector lever, the unlocking bar being operationally linked to a locking mechanism so that in a first position, a movement of the selector lever into at least one lever position is blocked and, in a second position, it is released, the unlocking bar being pre-tensioned in its first position by a pre-tension force; the selector lever has a sliding ramp coupled to an end section of the unlocking bar, which is movable by manual actuation of an unlocking element so that the unlocking bar is movable into its second position by the end section sliding down on the sliding ramp against the pre-tension force. The end section of the unlocking bar coupled to the sliding ramp is provided with a second material different from a first material of the remaining unlocking bar, which is lower friction than the first material with respect to a friction pairing with the handle.

### CROSS-REFERENCE TO RELATED APPLICATION

This application claims priority to German Patent Application No. 102009034695.3, filed Jul. 24, 2009, which is incorporated herein by reference in its entirety.

### TECHNICAL FIELD

The present invention is in the field of vehicle technology and relates to a selector lever for a speed change transmission, in particular of a motor vehicle, a speed change transmission having such a selector lever, and a motor vehicle equipped with such a speed change transmission.

### BACKGROUND

Selector levers for speed change transmissions, which are blocked by a locking mechanism in specific lever positions and may be manually unlocked with the aid of an unlocking element, are installed in mass production in modern motor vehicles. Through blocked selector levers of this type, for example, in the case of a manual shift transmission, unintentional engagement of the reverse gear or, in the case of an automatic transmission, inadvertent shift of the selector lever from operating position “N” (neutral) into operating position “R” (reverse) is prevented.

In this regard, at least one object of the present invention comprises advantageously refining a selector lever for a speed change transmission. Furthermore, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved with a selector lever for a speed change transmission. The selector lever for a speed change transmission, in particular of a motor vehicle, is disclosed according to an embodiment of the invention. The selector lever, which is provided on one end with a handle or knob, is movable into various lever positions to select various operating and driving steps in the case of an automatic transmission or various gears in the case of a manual shift transmission.

An unlocking bar, which is movable in the longitudinal or extension direction, is received in the selector lever, the unlocking bar being operationally linked to a locking mechanism so that, in a first position of the unlocking bar, a movement of the selector lever into one or more lever positions is blocked by the locking mechanism and, in a second position, the unlocking bar is released. For this purpose, the unlocking bar is pre-tensioned in its first position via a pre-tension force, for example, by the spring force of one or more spring means.

Furthermore, the selector lever has a sliding ramp, which is coupled to a handle-side end section of the unlocking bar, and which is movable by a manual actuation of an unlocking element so that the unlocking bar is movable against the pre-tension force by sliding down the sliding ramp into its second position, in which no lever position is blocked by the locking mechanism.

The handle-side end section of the unlocking bar, which is coupled to the sliding ramp, is provided with a second material, which is different from a first material of the remaining unlocking bar. The second material is lower friction than the first material with respect to a friction pairing between the second material of the end section of the unlocking bar and a third material of the handle. The second material accordingly has a lower coefficient of friction than the first material with respect to this friction pairing. The second material is, for example, polyoxymethylene (POM) a commercially-available technical plastic, which is distinguished by high strength and dimensional stability and by a relatively low coefficient of friction. The handle can be produced from polyamide (PA) having glass fiber components, for example. The unlocking bar can be manufactured from metal, for example, with the exception of the end section coupled to the sliding ramp.

Because not only a force in the extension direction of the unlocking bar but rather also a force acting perpendicularly thereto is exerted on the unlocking bar as the unlocking bar slides down the sliding ramp, a situation can occur in which the unlocking bar undesirably comes into touch contact with the handle. The selector lever advantageously allows that through reduced friction between the end section of the unlocking bar and the handle, premature wear because of a contact between unlocking bar and handle is prevented. In addition, permanent smooth unlocking of the selector lever can be ensured.

In an advantageous embodiment of the selector lever according to the invention, the unlocking bar is implemented in one piece, the end section of the unlocking bar comprising the second material and the remaining section of the unlocking bar comprising the first material.

In an alternative embodiment of the selector lever thereto, the unlocking bar is implemented in two pieces, the handle-side end section of the unlocking bar being formed by a separate end piece comprising the lower-friction second material. In this case, it can be advantageous if the end piece can be placed on the unlocking bar. In particular, the end piece can be implemented in the form of a cap which can be put on and which tapers conically toward the handle or knob. This embodiment of the invention allows a technically simple and cost-effective production of the selector lever in industrial mass production and additionally allows typical selector levers to be retrofitted easily.

In a further embodiment of the selector lever according to the invention, the unlocking bar is (partially) received in the lever tube carrying the handle, a play of the unlocking bar inside the lever tube being reduced by the end piece of the unlocking bar. The extent of movement of the unlocking bar perpendicular to the extension direction can advantageously be reduced by this measure. In this way, the intensity of a touch contact between the end piece of the unlocking bar and the handle can be reduced in particular, which has the result that undesired wear is reduced still further.

In a further embodiment of the selector lever according to the invention, the unlocking bar is (partially) received in a lever tube, the end piece of the unlocking bar being implemented so that the unlocking bar exclusively has touch contact to the lever tube via the end piece. Premature wear because of a touch contact between unlocking bar and lever tube can be reliably prevented by this measure. In this case, it can be advantageous that the second material of the end section of the unlocking bar coupled to the sliding ramp is lower friction than the first material with respect to a friction pairing with the lever tube. This is true in particular for the case in which the lever tube is manufactured from polyamide having glass fiber components.

In a further embodiment of the selector lever according to the invention, the unlocking element is implemented in the form of an unlocking button, which is mounted so it is movable, for example, pivotable, in the handle. In this case, it can be preferable for the sliding ramp to be formed by an insert part which is mounted so it is movable, for example, linearly displaceable, in the handle, the insert part being movable by the unlocking button so that the unlocking bar can be brought into its second position by sliding down the sliding ramp. This embodiment allows the use of various materials for insert part and unlocking button, which are selected specifically with respect to the particular requirements. For example, the unlocking button can be manufactured from a visually appealing material, such as chromium, while in contrast the material of the insert part is selected with regard to sufficient strength, hardness, and dimensional stability and a relatively low friction with respect to the friction pairing sliding ramp/end piece of the unlocking bar. In particular, at least the section of the insert part which forms the sliding ramp can be manufactured from the lower-friction second material, so that the end section of the unlocking bar and the insert part comprise the same, relatively low-friction material, whereby a relatively low friction is implemented between the friction pairing sliding ramp/end piece of the insert part.

The embodiments of the invention further extend to a change speed transmission, in particular for a motor vehicle, which is equipped with such a selector lever. This can be a change speed transmission having gears which can be manually shifted, such as a clutch sleeve transmission, or an automatic transmission having manually selectable operating or driving steps.

Furthermore, the embodiments of the invention extend to a motor vehicle having a change speed transmission of this type.

### BRIEF DESCRIPTION OF THE DRAWINGS

The present invention will hereinafter be described in conjunction with the following drawing figures, wherein like numerals denote like elements, and:

FIG. 1 shows an exemplary embodiment of the selector lever for a change speed transmission according to an embodiment of the invention; and

FIG. 2 shows an exemplary embodiment of a cap to be placed on the unlocking bar of the selector lever from FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

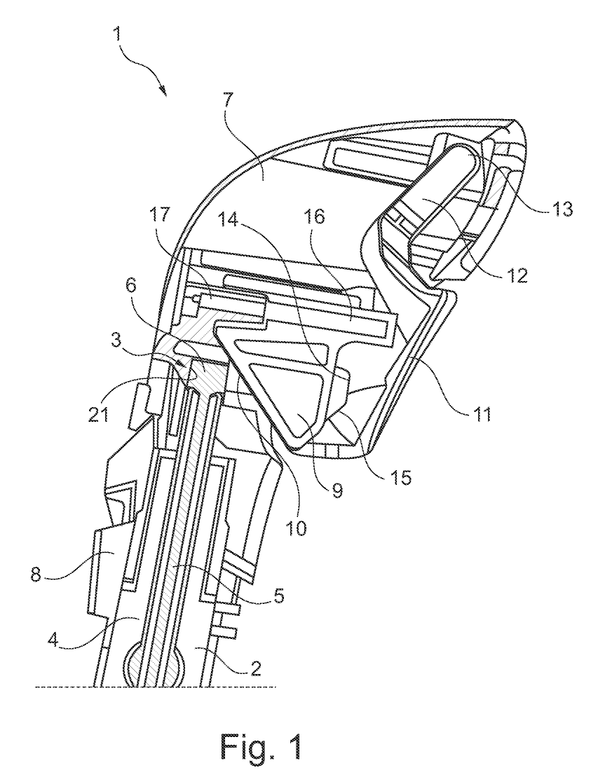

Accordingly, the selector lever 1 for a speed change transmission, which is only partially shown in FIG. 1, comprises a lever tube 2, which is linked at one end to a housing (not shown) of the change speed transmission so it is pivotable around one or two axes, for example. The linkage of a selector lever per se is well known to one skilled in the art, so that it does not need to be explained in greater detail here. The lever tube 2 is manufactured here from polyamide (PA) having glass fiber components, for example.

A handle or knob 7 encloses the free end section of the lever tube 2 using a hollow shaft section 8 and is non-positively connected and/or materially bonded thereto using a typical fastening technology. The selector lever 1 can thus be moved by manual actuation of the knob 7 into various lever positions to select various operating and driving steps in the case of an automatic transmission or various gears in the case of a manual shift change speed transmission.

An unlocking bar 5, which extends down into the knob 7, is received so it is longitudinally displaceable in the cavity 4 of the lever tube 2. It is operationally linked to a locking mechanism (not shown), so that in a first position of the unlocking bar 5, a movement of the selector lever 1 into at least one lever position is blocked by the locking mechanism and, in a second position, the unlocking bar 5 is released. The construction and function of such a locking mechanism are well known to a person skilled in the art through selector levers installed in mass-produced vehicles, for example, so that they do not have to be explained in greater detail here.

The unlocking bar 5 is pre-tensioned in its first position here by the spring force of a compression spring (not shown), for example, the first position being assumed by a displacement of the unlocking bar 5 directed toward the knob 7 and the second position being assumed by a displacement directed away from the knob 7.

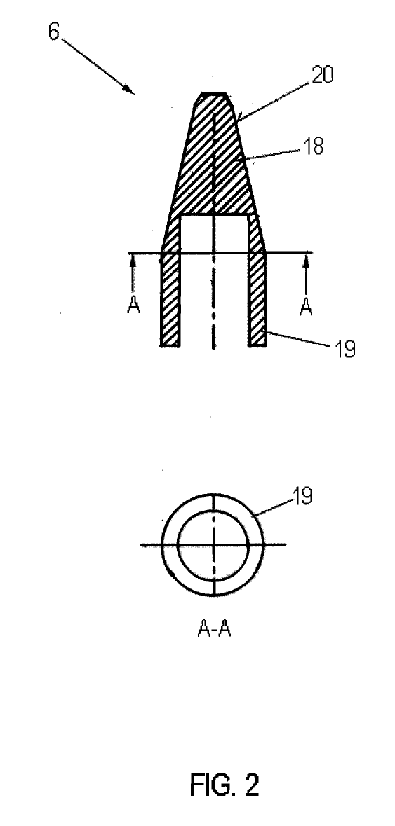

On its end section 3 facing toward the knob 7, the unlocking bar 5 is provided with a cap 6, which is implemented as a separate molded part. As may be inferred from FIG. 2 in particular, the cap 6 is composed of a first cap section 18 in the form of a truncated cone having an external surface 20 conically tapering toward the knob 7 and a second cap section 19 in the form of a pipe socket. The cap 6 is placed on the unlocking bar 5, the second cap section 19 in the form of a pipe socket being implemented in a matching shape to the unlocking bar 5. The cap 6 is fastened on the unlocking bar 5 by the clamping action of this snug fit and forms the end section 3 of the unlocking bar 5 in this case.

Furthermore, the knob 7 is provided with an unlocking button 11, which is mounted so it is pivotable around a pivot axis 13 via a pivot arm 12. The unlocking button 11 cooperates with an insert part 9, which is mounted in the knob 7 so it is displaceable in a linear guide 17 via a guide section 16. A mechanical force can be transmitted between the unlocking button 11 and the insert part 9 via a first pressure surface 14, which presses flatly against a second pressure surface 15 of the insert part 9.

The insert part 9 is provided with a running or sliding ramp 10, which is implemented in the form of a surface situated diagonally to the extension or displacement direction of the unlocking bar 5. The sliding ramp 10 is in continuous touch contact with the cap 6, i.e., the end section 3 of the unlocking bar 5. The external surface 20 of the cap 6 is implemented in a suitable matching shape to the sliding ramp 10.

If the insert part 9 is displaced by manual actuation of the unlocking button 11 in the direction toward the unlocking bar 5 (to the left in the illustration of FIG. 1), the cap 6 slides down the sliding ramp 10, the unlocking bar 5 being displaced in the longitudinal direction away from the knob 7 (downward in the illustration of FIG. 1). The unlocking bar 5 is thus brought into its second position, in which the lever position of the selector lever 1 is unlocked. Upon unlocking of the locking mechanism, the spring force of the compression spring which pre-tensions the unlocking bar 5 must be overcome.

On the other hand, the unlocking bar 5 can be restored into its first position by the pre-tensioning spring force, the insert part 9 being displaced by sliding down of the cap 6 on the sliding ramp 10 (to the right in the illustration of FIG. 1) and the unlocking button 11 being brought into its starting position.

Because the sliding ramp 10 is placed diagonally to the displacement or extension direction of the unlocking bar 5, upon manual actuation of the unlocking button 11, a first force component in the direction of the displacement direction of the unlocking bar 5 and a second force component perpendicular thereto occur. The cap 6 is pressed against the contact surface 21 of the knob 7 by the second force component, whereby a friction force is generated between the cap 6 and the contact surface 21 of the knob 7.

The knob 7 is manufactured from polyamide (PA) having glass fiber components here. In order to reduce the friction force in the friction pairing cap 6/knob 7, the cap 6 is manufactured from a friction-reducing material, polyoxymethylene (POM) here, for example. The remaining part of the unlocking bar 5 is produced from metal, in order to ensure sufficient strength and dimensional stability upon the force transmission to the locking mechanism. Premature wear is prevented by the cap 6 comprising polyoxymethylene (POM), which typically results in exposure of glass fiber components in the knob 7, through which the friction forces occurring upon displacement of the unlocking bar 5 could be increased strongly until the occurrence of a clamping effect.

The cap 6 is shaped so that a play of the unlocking bar 5 within the cavity 4 of the lever tube 2 is reduced thereby, with the result that the friction force occurring at the contact surface 21 of the knob 7 is reduced. In addition, the cap 6 is shaped so that the unlocking bar 5 exclusively has a touch contact to the lever tube 2 via the cap 6. Because the lever tube comprises polyamide, wear by touch contact would also result in exposure of glass fiber components in the lever tube 2, by which the friction force between unlocking bar 5 and lever tube 2 occurring upon displacement of the unlocking bar 5 could be strongly increased until the occurrence of a clamping effect. For this purpose, the cap 6 at least sectionally has a dimension, measured perpendicularly to the extension direction of the unlocking bar 5, which is greater than that of the unlocking bar 5.

In accordance with embodiments of the invention, a selector lever is provided for speed change transmissions that advantageously refines typical selector levers, in that an end section of the unlocking bar has a friction-reducing material with respect to the friction pairing of knob/unlocking bar and optionally unlocking bar/lever tube. The end section of the unlocking bar can particularly be implemented in the form of an attached cap.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A selector lever for speed change transmissions, which is movable into lever positions to select various operating and driving steps or gears, comprising:
a handle at one end;
an unlocking bar that is movable in an extension direction and received in the selector lever, the unlocking bar operationally linked to a locking mechanism so that in a first position, a movement of the selector lever into at least one lever position is blocked and, in a second position, the unlocking bar is released, the unlocking bar is pre-tensioned by a pre-tension force in the first position; and
a sliding ramp of the selector lever that is coupled to an end section of the unlocking, and movable by manual actuation of an unlocking element so that the unlocking bar is movable into the second position by sliding of the end section down the sliding ramp against the pre-tension force, the sliding ramp coupled to the end section of the unlocking bar having with a second material that is different from a first material of a remaining portion of the unlocking bar, and which is lower-friction than the first material with respect to a friction pairing with the handle.

2. The selector lever according to claim 1, wherein the unlocking bar is implemented in one piece.

3. The selector lever according to claim 1, wherein the unlocking bar is implemented in two pieces, the end section of the unlocking bar, which is coupled to the sliding ramp, formed by an end piece comprising the second material.

4. The selector lever according to claim 3, wherein the end piece can be placed on the unlocking bar.

5. The selector lever according to claim 4, wherein the end piece is implemented in a form of a conically tapering cap.

6. The selector lever according to claim 3, wherein the unlocking bar is received in a lever tube, a play of the unlocking bar within the lever tube reduced by the end piece of the unlocking bar.

7. The selector lever according to one of claim 3, wherein the unlocking bar is received in a lever tube, the end piece of the unlocking bar implemented so that the unlocking bar exclusively has a touch contact to the lever tube via the end piece.

8. The selector lever according to claim 7, wherein the second material of the end section of the unlocking bar, which is coupled to the sliding ramp, is a lower friction than the first material with respect to a friction pairing with the lever tube.

9. The selector lever according to one of claim 1, wherein the lower friction second material is polyoxymethylene.

10. The selector lever according to one of claim 1, wherein the unlocking element is an unlocking button that is mounted to move in the handle.

11. The selector lever according to claim 10, wherein the sliding ramp is formed by an insert part mounted to move in the handle, the insert part adapted to move by the unlocking button so that the unlocking bar can be brought into the second position.

12. The selector lever according to claim 11, wherein at least a section of the insert part forming the sliding ramp comprises the lower-friction second material.
